(19) United States
(12) Patent Application Publication
(10) Pub. No.: US 2011/0161468 A1
(43) Pub. Date: Jun. 30, 2011

(54) METHOD AND SYSTEM FOR CASCADING PEER-TO-PEER CONFIGURATION OF LARGE SYSTEMS OF IEDS

(75) Inventors: David Tuckey, Victoria (CA); Trever Blair, North Saanich (CA); Basem Elwarry, Victoria (CA)

(73) Assignee: Schneider Electric USA, Inc., Palatine, IL (US)

(21) Appl. No.: 12/651,098

(22) Filed: Dec. 31, 2009

(51) Int. Cl. G06F 15/177

(52) U.S. Cl. 709/220; 709/224

(57) ABSTRACT

A method and system of efficiently distributing configuration information for IEDs across one or more networks in an electrical monitoring system is disclosed. Changing configuration information is managed by a configuration management system. The IEDs in the network or networks are organized in peer relationships, each peer relationship having at least one seed IED. The configuration information is loaded to the seed IED or seed IEDs which make the configuration parameter available to other IEDs in a peer relationship with the seed IED. The other IEDs may in turn become seed IEDs for other IEDs. The configuration information therefore cascades throughout the network without further communication between the configuration management system and the selected IEDs.

### FIELD OF THE INVENTION

The present invention relates generally to power monitoring and protection systems using multiple intelligent electronic devices, and in particular, to a method and system for propagating configuration parameters using peer-to-peer cascades to the intelligent electronic devices.

### BACKGROUND OF THE INVENTION

Modern power monitoring systems often include intelligent electronic devices (IEDs) that assist in providing a greater variety of data and having greater utility due to the ability to configure such devices to perform numerous functions. Often monitoring systems may have dozens or hundreds of IEDs that monitor various points in the system.

It is very difficult and time-consuming to properly configure and maintain all of the individual IEDs of even a moderately-sized power monitoring system, which may include hundreds of devices that must be configured properly. Each individual device must be configured, one at a time, requiring extensive knowledge by the installer of the particular configuration parameters for each device. It is difficult for the operator to remember all of the proper configuration parameters and associated values, yet very easy for the installer to improperly configure a device or neglect to configure a device at all. In some systems, many devices need to be configured in the same way, but the operator can easily misconfigure one or more of such devices by entering an incorrect configuration parameter value. The installer also has no easy way of determining whether any discrepancies exist among configurations or whether the configuration of any particular device differs from that of any other device. More time can be spent double-checking or verifying the configuration of all of the devices prior to commissioning, and it can take several days to configure properly all of the capable devices as part of commissioning a power monitoring system. Improper or incomplete configuration can result in misoperation of the power monitoring system and/or costly project overruns.

Classic systems have a head end Configuration Management System (CMS) that downloads such configuration information directly to each IED. In these systems, even if the CMS is powerful enough to download configuration information to several IEDs at a time, it still can take a great deal of time to propagate the configuration information to all the IEDs in the system. This is especially true if the network is a slower serial type network or if there is a slower network bridge such as a modem to other components of the network.

What is needed is an automated method of propagating extensive amounts of configuration information among multiple intelligent electronic devices in an electrical monitoring system without extensive communications directly between such devices and their associated configuration management system. It is also desirable to reduce the overall elapsed time for configuring the IEDs in an electrical monitoring system.

### SUMMARY OF THE INVENTION

According to at least some aspects of the present disclosure a configurable monitoring system having at least one network is disclosed. The monitoring system has a plurality of configurable intelligent electronic devices (IEDs) coupled to the at least one network. At least a first configurable IED is a seed IED having a peer-to-peer relationship with a second IED. A configuration management system (CMS) is coupled to the at least one network. The CMS includes a storage device storing a master list of configurations of the IEDs and their associated configuration information for each of the plurality of configurable IEDs on the at least one network. The CMS sends at least some part of new configuration information to the first seed IED and the at least some part of the new configuration information is transferred between the first seed IED and the at least one other second IED.

Another example relates to a method of configuring IEDs in a network via a configuration management system (CMS). A peer-to-peer relationship is established between at least a first and a second IED of a plurality of IEDs. The relationship includes designating at least one first seed IED and one second peer IED respectively in the relationship. At least two of the IEDs are alerted of a change in configuration. At least some part of new configuration information is distributed from the CMS to the seed IED. A peer-to-peer communication is established to the seed IED to transfer the at least some part of new configuration information to the peer IED.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is a functional block diagram of an exemplary electrical monitoring system that includes a configuration management system and multiple intelligent electronic devices allowing the configuration of the devices; and

FIG. 2A is a network diagram of the electrical monitoring system in FIG. 1 with certain peer-to-peer relationships that allows cascading of configuration information between the multiple intelligent electronic devices in FIG. 1;

FIG. 2B is an alternate network diagram of the electrical monitoring system in FIG. 1 with other possible peer-to-peer relationships that allows cascading of configuration information between the multiple intelligent electronic devices in FIG. 1;

FIG. 3 is a flow diagram of the use of peer-to-peer cascading to increase the efficiency of updating configuration information for intelligent electronic devices of the electrical monitoring system of FIG. 1.

### DETAILED DESCRIPTION OF THE ILLUSTRATED EMBODIMENTS

Although the invention will be described in connection with certain aspects and/or embodiments, it will be understood that the invention is not limited to those particular aspects and/or embodiments. On the contrary, the invention is intended to cover all alternatives, modifications, and equivalent arrangements as may be included within the spirit and scope of the invention as defined by the appended claims.

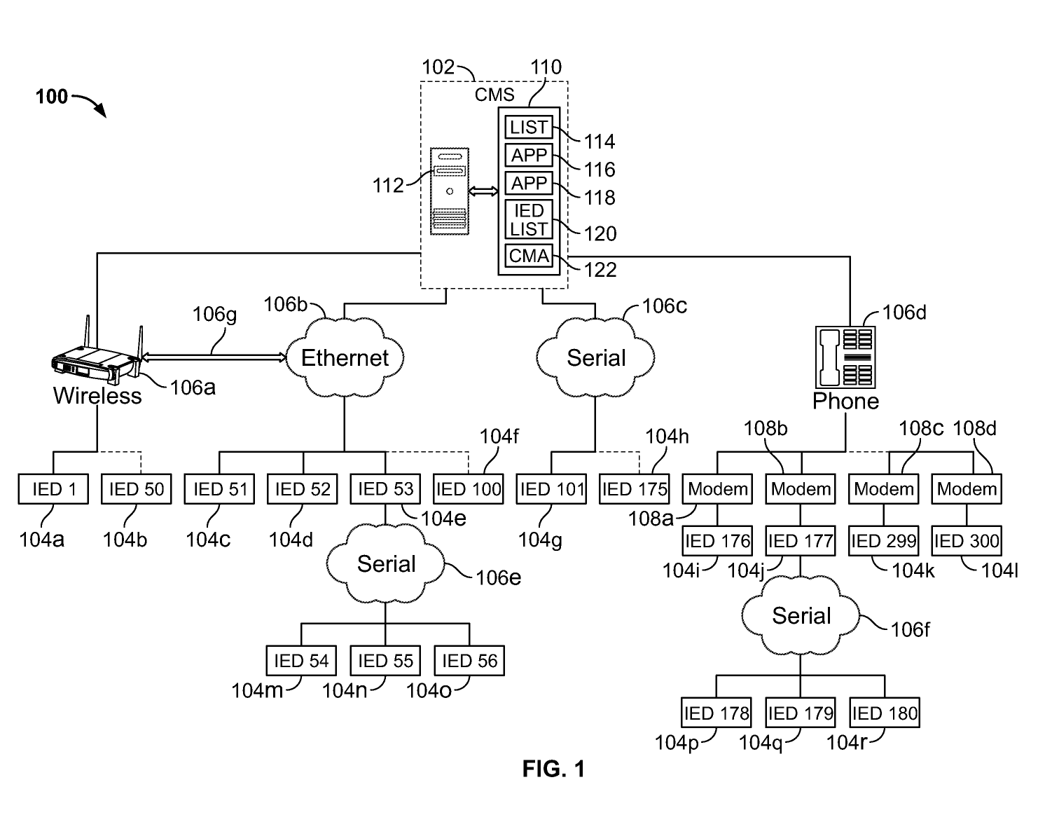

FIG. 1 is a functional block diagram of an electrical or power monitoring system 100 that includes a configuration management system (CMS) 102, which is coupled to intelligent electronic devices (IEDs) 104a-r through various wired and wireless networks 106a-f. Further description of the operation of the CMS 102 may be found in application Ser. No. 12/220,840 filed Jul. 29, 2008, and hereby incorporated by reference in its entirety. IEDs 104a,b are communicatively connected to the CMS 102 via a wireless network 106a. IEDs 104c-f are communicatively connected to the CMS 102 via an Ethernet network 106b. IED 104e serves as a master to IEDs 104m-o, which are communicatively connected to the master IED 104e via a serial network 106e. IEDs 104g,h are communicatively connected to the CMS 102 via a serial network 106c. IEDs 104i-1 are communicatively connected to the CMS 102 via a plain old telephone (“POTS”) network 106d. Respective modems 108a-d are connected between the IEDs 104i-1. IED 104j serves as a master to IEDs 104p-r via a serial network 106f. Any one or more of the serial networks 106c,e,f can be ION, MODBUS® or JBUS networks.

As shown in FIG. 1, all of the IEDs 104a-r have a unique numerical identifier, e.g., IED 104a is IED 1, IED102b is IED50, etc. In this example, the wireless network 106a includes fifty IEDs represented by IED 104a (IED1) through IED 104b (IED50). Correspondingly, the primary Ethernet network 106b includes fifty IEDs represented by IED 104c, (IED51), IED 104d, (IED52), and IED 104e, (IED53) through IED104f (IED 100). In this example, the serial network 106c includes seventy-five IEDs represented by IED 104g (IED101) through IED 104h (IED175). In this example, the telephone network 106d includes 125 IEDs ranging from IED 104i (IED 176) to IED 1041 (IED 300). Some IEDs such as IEDs 104p (IED 178), IED 104q (IED179) and IED 104r (IED180) are coupled through a secondary network such as the secondary serial network 106f.

As used herein, an IED refers to any system element or apparatus with the ability to sample, collect, or measure one or more operational or electrical characteristics (e.g., power, current, voltage, distortion, power factor, energy, demand, harmonics) or parameters of the electrical monitoring system 100. For example, the IED may be based on a PowerLogic® Series 3000/4000 Circuit Monitor or a PowerLogic® ION7550/7650 Power and Energy Meter available from Schneider Electric or any other suitable monitoring device (e.g., circuit monitor), a circuit breaker, a relay, a metering device, or a power meter. The IED may also be a communications gateway, one exemplary model being a PowerLogic® ION7550RTU. Each IED can also store data indicative of the measured electrical characteristic.

Each of the IEDs 104a-r has a network interface, a memory storage device, and a controller that can be configured via a set of configuration information such as commands/parameters or software that is programmable via various programs that can be loaded via the respective network 106a-f from the network interface on the IED. The corresponding configuration parameters and/or programming are stored on the respective IEDs 104a-r. The configuration parameters include any one or more of the following: device type (e.g., a CM3000 circuit monitor), identification information (e.g., TENANT1BUILDING4), unit of measurement, a feature library (e.g., which IED features should be enabled or disabled), pickup and dropout alarm thresholds, user preferences and user-defined quantities, types of data for the IED to log (e.g., energy-related data), IED setup information, IED settings, a threshold of an electrical characteristic (e.g., power, current, voltage, distortion, power factor, energy, demand, harmonics are examples of electrical characteristics) monitored by the IED, a rated transformer voltage at the IED, alarms, watchdogs, audit events, energy register rollover, pulse width of energy pulse outputs, firmware versions, program versions, communications settings (e.g., baud rate, parity, device address, communications protocol such as MODBUS®, JBUS, or TCP/IP, port number, delay parameters), clock synchronization method (e.g., synchronize to GPS, synchronize to line frequency, synchronize to internal clock), time synchronous source (e.g., COM port, optical port, Ethernet port), time zone offset, daylight savings time offset, standard or custom nameplate information (e.g., owner information, facility information, unique meter tag number, manufacturer serial number), maximum number of metrological (e.g., kWh, kVArh) records to be stored, number of restarts, number of control power failures, date and time information, phase correction factors, calibration information, current transformer (CT) and potential transformer (PT) ratios and other transformer information, the size of datalogs, power demand calculation method (e.g., sliding window, thermal), power demand interval, nominal system frequency, diagnostics, operating mode parameters, peak demand, passwords, and the like. Examples of alarm thresholds include voltage thresholds (e.g., root-mean-square (RMS) values, harmonic components, total harmonic distortion), transient thresholds, and current thresholds (e.g., RMS values, harmonic components, total harmonic distortion). Some configuration parameters can be read only, others can be read/write. The parameter values correspond to a value (which can be numeric, alphanumeric, or any combination of characters) of a configuration parameter. For example, the configuration parameter “device type” can have a parameter value “CM3000.” For example, the configuration parameter “nominal system frequency” can have a parameter value “60,” which represents a frequency of 60 Hz. As used herein, a “configuration parameter” can include a firmware or software version. Corresponding parameter values of such firmware or software version would include the version number, for example, and the name of the firmware or software.

In this example, the CMS 102 includes a conventional computer server 112 coupled to a storage device 110 (such as a database storage device) on which a master list 114 that describes which firmware or configuration parameter template should correspond to each IED 104a-r in the electrical monitoring system 100. The CMS 102 also stores on the storage device 110 copies of firmware, program versions, and configuration parameter templates (including their corresponding parameter values) 116 to be deployed to any one or more of the IEDs 104a-r. The CMS 102 also stores on the storage device 110 rules 118 for unattended checking of the IEDs 104a-r and deployment of firmware or parameter values from the configuration parameter template or as entered by the user. The CMS 102 also stores on the storage device 110 a list 120 of the IEDs 104a-r detected in the electrical monitoring system 100.

As shown in FIG. 1, in some cases, configuration information such as configuration parameters or programming is communicated across a primary communication link, such as via the wireless network 106a or the serial network 106c. In other cases, the configuration information is communicated across secondary communication links, such as via the primary Ethernet network 106b and the secondary serial network 106e or via the primary phone network 106d and the secondary serial network 106f. There can also be bridge links such as the bridge link 106g between networks such as the wireless network 106a and the Ethernet network 106b, allowing direct communication between IEDs on both networks.

Upon initialization of the CMS 102, a configuration management algorithm 122 stored on the storage device 110 and running on the server 112 creates the list 120 of all IEDs in the electrical monitoring system 100 that are capable of being detected through the various networks 106a-f in the electrical monitoring system 100. The CMS 102 performs handshaking with the IED 104, which sends identification data indicative of the identity of the IED (e.g., type of IED, manufacturer identification information, model information, and the like) to the CMS 102, which stores the identification information associated with each IED in the list of IEDs 120 on the storage device 110.

In this example, the configuration management algorithm 122 intelligently scans the networks 106a-f in the electrical monitoring system 100 to detect the IEDs 104 and to read their configuration information automatically. The configuration management algorithm 122 automatically detects newly added IEDs, determines the type of IED, adds it to the list of IEDs 120 on the storage device 110, and configures the newly added IED.

The configuration management algorithm 122 reads or scans the configuration data (which includes the parameter values and programming) from each of the IEDs 104a-r and stores the configuration data associated with each of the IEDs 104a-r in the master list 114 on the storage device 110. The CMS 102 receives the configuration data from each IED in a similar manner that the CMS 102 receives the identification information as described above. The initial identification of IEDs and their respective configuration data is referred to as the pre-scan mode of operation. The pre-scan creates a “baseline” of identification information and configuration data against which subsequent scans can be compared.

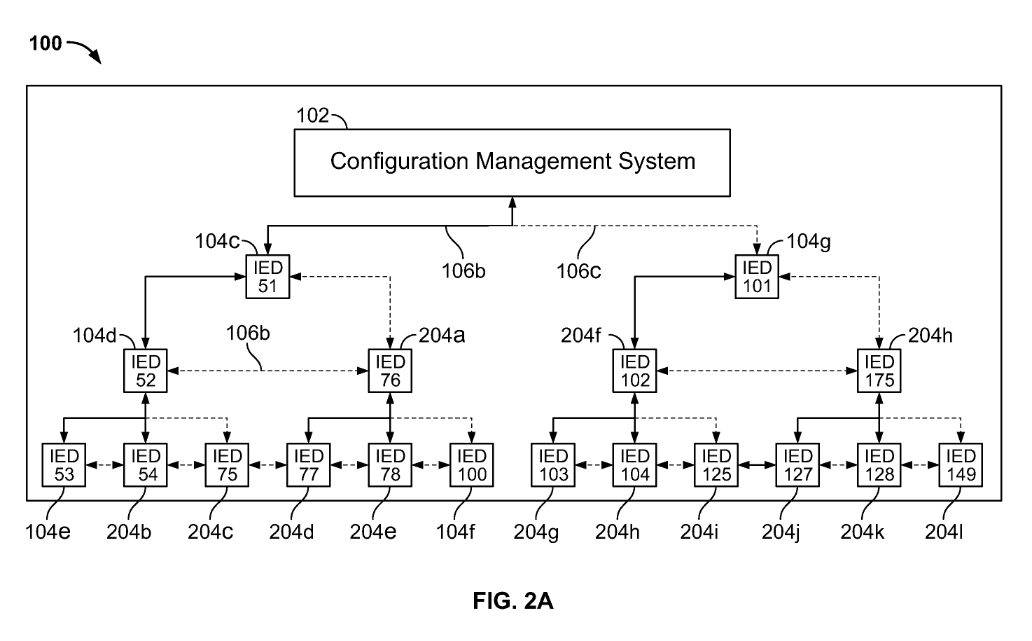

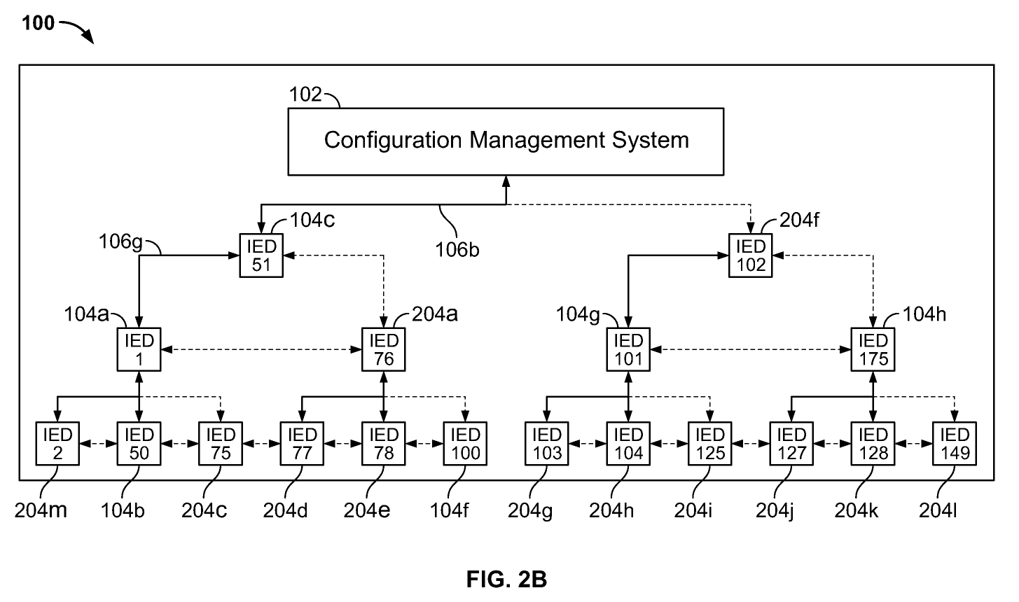

Updated configuration information such as configuration parameters or programs (including software or firmware executable by a controller on the IED) can be cascaded via peer-to-peer communications among the IEDs, which simplifies the process of upgrading or reconfiguration of similar IEDs among the IEDs 104a-r, such as all IEDs that are power meters. The process eliminates the need for direct communication between the CMS 102 and each of the IEDs 104a-r that require the new configuration information such as new or updated software programs or configuration parameters. The process of cascading new configuration information uses peer-to-peer relationships between IEDs. FIGS. 2A and 2B are network diagrams of example network and peer relationships between the physical components of the electrical monitoring system 100 in FIG. 1. Additional IEDs such as IEDs 204a-1 have been added in FIGS. 2A and 2B that are not shown in FIG. 1. In FIG. 2A, various IEDs of the IEDs 104a-r in FIG. 1 and IEDs 204a-1 of one type such as meters are grouped together for purposes of distributing configuration information to each of the same type of IEDs. The IEDs specified in FIG. 2A have various IEDs that are in network communication with each other forming a peer relationship. In FIG. 2A, the IED 104c (IED51) is considered the peer to IED 104d (IED52) and the IED 204a (IED76). In turn, the IED 104d is a peer of the IED 104e (IED53), IED 204b (IED54), and IED 204c (IED75). The IED 204a (IED76) is a peer of the IED 204d (IED77), the IED 204e (IED78), and the IED 104f (IED100). These peer relationships are defined by the common Ethernet network 106b that includes IEDs such as 104c, 104d, 104e, 204a, 204b, and 204c. Separate peer relationships may be established on another network such as the serial network 106c. In the serial network 106c, the IED 104g (IED101) is a peer of the IED204f (IED102) and the IED 104h (IED175). In turn, the IED 204f (IED102) is a peer of a set of IEDs 204g (IED103), 204h (IED104), and IED 204i (IED125). Similarly, the IED 104h (IED175) is a peer of a set of IEDs 204j (IED127), 204k (IED128), and IED2041 (IED 149).

In the cascading process involving the peer-to-peer relationships, a “seed” is defined as a peer IED that has the ability to supply a copy of configuration information (e.g., a software or firmware program, an upgrade file, or a configuration parameter file). In the described approach, each IED will maintain its own list of seeds (including information about how to communicate with each seed, such as addressing information). In the example in FIG. 2A, each of the IEDs 104c (IED51) and 104g (IED101) will be designated as seeds and have their own peer relationships as explained above. Certain IEDs that are in a peer relationship with the seed IED may become seeds for other IEDs. For example, in FIG. 2A the IED 104c (IED51) is a peer of the IED 104d (IED52) and the IED 204a (IED76). The IED 104d (IED52) serves as a seed IED to the peers IED 104e (IED53), IED 204b (IED54), and IED 204c (IED75) while the IED204a (IED76) serves as a seed IED to the peers IED 204d (IED77), IED 204e (IED78), and IED 104f (IED100). In this manner, communication of configuration information can be cascaded from the initial seed IEDs receiving the configuration information from the CMS 102 to the respective peer IEDs of the initial seed IEDs without requiring the CMS 102 to be involved in the communications, alleviating significant processing burden from the CMS 102 and freeing up the CMS 102 to carry out other tasks.

The configuration management algorithm 122 of the CMS 102 also designates seeds for the peer-to-peer relationships for each of the IEDs 104. Each IED 104 maintains its own list of seeds (including information about how to communicate with each seed, such as network addressing information), which the IED uses for searching and retrieval of files and configuration information.

There are several alternate ways of establishing the list of seeds for each IED 104. The CMS 102 can communicate directly with each IED 104 via the networks 106 to program each respective list of seeds. The CMS 102 can choose to specifically identify the possible propagation paths within the electrical monitoring system 100 to tightly control the paths by which files will be disseminated. This approach is preferable in implementations where the communication path is not shared among all devices in the system (for example, the serial and modem links 106c and 106d in FIG. 1). Referring to FIG. 2A, several examples of how the CMS 102 can choose to program seed information for the selected IEDs in the electrical monitoring system 100 for an upgrade using this approach are shown via the lines between the IEDs. For example, the seed(s) for the IED 104d (IED52) can include IED 104c (IED51) or IED 204b (IED76), which may be chosen because these IEDs are all part of the Ethernet network 106b. Similarly, the seed(s) for the IED 204b (IED76) can include the IED 104c (IED51) and the IED 104d (IED52). At the next peer relationship, the seed(s) for the IED 104e (IED53) can include the IED 104d (IED52), IED 204b (IED54), IED 204c (IED75), IED204d (IED77), IED204e (IED78), and IED 104f (IED100), all of which are part of the Ethernet network 106b allowing easy communication between the possible seeds and the IED 104e (IED53).

FIG. 2B shows alternate seeds and peer relationships that can be established with the IEDs 104 and 204 in FIGS. 1 and 2B. Peer relationships can be established between two networks if a bridge such as the bridge 106g exists between the networks 106a and 106b. As in FIG. 2A, the IED 104c (IED51) serves as a seed IED. The IED 104c (IED51) is a peer of the IED 104a (IED1) on the network 106a and the IED 204a (IED76) on the network 106b. This peer relationship is possible because of the bridge 106g between the networks 106a and 106b. In turn, the IED 104a (IED1) is a peer of an IED 204m (IED2) and the IED 104b (IED50) both on the serial network 106b and the IED 204c (IED75) on the Ethernet network 106b.

FIG. 2B also shows how different IEDs in a peer relationship can be designated as seed IEDs. As with FIG. 2A, the IEDs 104h (IED 175), 204f (IED102), and IED 104g (IED101) are peers. In FIG. 2B, the initial seed IED is now IED 104h (IED175). The IED 104g (IED101) and IED 204f (IED102) serve as seed IEDs to other IEDs such as a set of IEDs 204g (IED103), 204h (IED104), and IED 204i (IED125) for the IED 104g (IED101) and IEDs 204j (IED127), 204k (IED128), and IED2041 (IED 149) for the IED 204f (IED102).

Alternatively, the CMS 102 can also be used to program a superset of most or all of the IEDs 104 as seeds to each other, to allow maximum flexibility in how data such as configuration information is disseminated. This approach is preferable in implementations where one communication medium is shared among most or all devices in the system. For example, an Ethernet network such as the network 106b coupled to IEDs 104c-f and IEDs 204a-e represented by the lines between each of the IEDs 104c-f and IEDs 204a-e in FIG. 2A can use any or all of the IEDs as seeds to each other. Using this alternative approach, the CMS 102 can initiate a system-wide upgrade by sending configuration information in the form of an upgrade/configuration file to any of the possible seed IEDs. Thus, any of the IEDs is capable of retrieving the files from any other IEDs because all of them are seeds of each other.

Another approach involves each IED self-discovering potential seeds with no programming necessary from the CMS 102. Using this approach, each IED can still maintain a list of seeds, but that list is populated by the IED itself using established peer discovery techniques.

As will be explained below, changes to the IEDs 104 and 204 can use the established peer-to-peer and seed relationships to minimize use of the CMS 102. Once the requested changes to the affected IED(s) 104 have been made, the configuration management algorithm 122 updates the master list 114 with the updated information (configuration parameters, settings, firmware version, program version) so that during the next analysis of configuration data, the configuration management algorithm 122 does not flag any of the requested changes as anomalies. The configuration management algorithm 122 can optionally confirm with the user that the configuration data associated with the one or more IEDs under consideration is correct.

Although the aspects described above refer to the configuration management occurring at a central CMS 102, in other aspects, there can be multiple device configuration servers located throughout the electrical monitoring system 100, that carry out the functionality of the CMS 102 at a “local” level. These servers can take the form of a computer, a programmed logic controller (PLC), a remote terminal unit (RTU), or other embedded device.

The configuration management algorithm 122 can be visually displayed to the user in the format of a wizard, to help walk the user through the steps for configuring and verifying the configuration of the various IEDs. It can be incorporated into, for example, the PowerLogic® ION® EEM enterprise energy management software available from Schneider Electric.

An exemplary process on the electrical monitoring system 100 includes peer-to-peer cascading of configuration information that decreases the resources required from the CMS 102 and increases the speed, accuracy, and efficiency of configuring the individual IEDs 104 and 204. The peer-to-peer cascading requires that the IEDs to be upgraded or reconfigured are of the same type and are capable of communication with each other over the networks 106a-f. It is preferable that each of the IEDs 104 and 204 in FIGS. 1-2 to be configured has a relatively large amount of memory available and to be linked via a peer-to-peer protocol that allows files and data to be uploaded to each IED. In this example, upgrade and reconfiguration actions are both accomplished by transferring a file including configuration information to an IED over the appropriate network interface.

An example process of cascading configuration information includes: a) initiating an upgrade or reconfiguration of an IED based on configuration information on all or a subset of the network of IEDs 104 and 204; b) the IEDs 104 and 204 obtaining the new upgrade or reconfiguration file through cascading peer-to-peer transfer; and c) the IEDs 104 and 204 starting to operate using the new upgrade or reconfiguration file.

In this example, the user is in control of deciding when and how many of the IEDs 104 and 204 in the electrical monitoring system 100 will be configured, or reconfigured. The configuration management algorithm 122 polls for a user input to determine whether the user has selected a group of IEDs for updating or changes in configuration information. When either the configuration management algorithm 122 or the user indicates that a change to one or more IEDs needs to be made, the configuration management algorithm 122 causes the change or changes to the configuration parameters, settings, firmware, or program stored on the affected IED(s) to be made via the server 112 of the CMS 102. The server 112 in the CMS 102 communicates with the required seed IEDs among the IEDs 104 and 204 via one or more of the networks 106a-f to cause changes to a particular LED's configuration parameters, settings, firmware, or program to be made.

The user controls the CMS 102 to set up how the IEDs 104 and 204 are updated with new configuration information. The user may designate that the IEDs 104 and 204 are all updated the same or alternatively, the user may designate sub-groupings of IEDs 104 and 204 to be updated in a similar manner. The user may also designate that all of the IEDs 104 and 204 are updated at the same time or designate times for different groups of the IEDs 104 and 204 to be updated. The user may also designate that all IEDs are updated automatically when there is a particular event (such as a new configuration information pushed to the CMS 102), or updated only when a user performs a specific command sequence at the CMS 102.

There are a number of ways to alert the chosen IEDs when they need to begin looking for new updates from their peer IEDs. For example, the CMS 102 can communicate to the chosen IEDs individually over the appropriate networks 106a-f and provide them the relevant information of when to look for new configuration information. These communications involve very minimal information, and thus typical systems would be efficient enough to deliver these instructions from the CMS 102 to the designated IEDs quickly. A specific instance of this case can involve all of the IEDs regularly checking their seeds for new updates on an ongoing basis, without any further direct communication from the CMS 102.

An alternative method to alert the chosen IEDs involves the CMS 102 creating a list file identifying the chosen IEDs and when they are to look for updated configuration information from the various seed IEDs. The list file is sent from the CMS 102 to the initial seed IEDs. In the meantime, the remaining IEDs regularly check their respective seed IEDs to see if a new list file has been loaded on their seed IED(s). The remaining IEDs pull down the list file from the seed IED over the network(s) 106a-f. The respective peer IEDs open the list file and follow the instructions in the list file for receiving the new configuration information. The CMS 102 begins the cascading of the updated configuration information by writing the new configuration information in the form of a configuration information file to the initial seed IEDs. Alternatively, the list file could be written to the initial seed IEDs at the same time as the new configuration information file is written to the initial seed IEDs.

Once an upgrade or configuration action has been initiated, the peer-to-peer transfer of configuration information files can begin to the IEDs. This process involves: a) seed establishment as explained above; b) configuration information file retrieval; c) establishing further seeds; and d) listing the file usage.

After establishing the proper relationships with IED seeds, the selected IEDs are instructed to upgrade and configure themselves with the new configuration information. The instruction to upgrade or configure an IED 104 or 204 may be explicit (through a request received through direct communication with the CMS 102 or through the seed IED) or implied (where the IED is instructed to always seek out the latest configuration information available, either continually or at powerup).

By the definition of peer-to-peer communications, peers are both suppliers and consumers of resources. The IEDs retrieving a configuration information file are acting as consumers (but may later act as suppliers), and the seed IED(s) are acting as suppliers (but may have earlier acted as consumers). The process of cascading configuration information throughout the IEDs in FIGS. 2A-2B can be viewed as using a “decentralized” peer-to-peer network, where the consumer IEDs contact the supplier IEDs directly for the requested configuration parameter(s), instead of communicating through the central server 112 of the CMS 102 to coordinate the configuration information file transfer.

This approach encompasses both Ethernet networking environments and other media, for example, serial communication links such as the network 106e where a number of IEDs are connected serially through a gateway IED 104e that may communicate back to the CMS 102 via the Ethernet network 106b. Ethernet networking environments inherently support peer-to-peer communications, as a proper network will handle routing and collision avoidance for packets sent from many different IEDs at the same time. Communications over other media (such as the serial network 106c which may be a serial RS-485 link) will typically need to employ some additional collision avoidance techniques (for example, a token ring scheme), due to the common master-slave behaviour where a single master is expected to initiate all communication requests. These collision avoidance techniques will simply ensure that the master is not actively communicating before a slave IED sends a peer-to-peer request to its seed IEDs, to avoid complications with bus contention.

Each IED 104 and 204 in the electrical monitoring system 100 conducts the following steps. Each IED 104 and 204 periodically checks connected seed(s) for a copy of the new information file. Using the list of seeds on the IED, each IED sends a peer-to-peer communication request to each of its seeds to request a copy of the new configuration information file. The peer-to-peer request contains identifying information about the requested file (for example, the version number for an upgrade or program file), and the peer-to-peer response from the seed indicates whether or not the seed has a copy of the configuration information file. If the first set of requests shows no seeds with the requested configuration information file, the IED waits for a short (possibly configurable) time, and then retries the request for the configuration information file. The IED continues to periodically check its seeds indefinitely, or it can alternatively cycle through a preset number of attempts before failing and returning to the default state.

Once the IED successfully sends its requests, it retrieves a copy of the configuration information file from the identified seed(s) using peer-to-peer communications. Once one or more seeds are found that can supply the requested configuration information file, each consumer IED will use a peer-to-peer protocol to retrieve the associated file from the seed (supplier) IED(s). The consumer IED may retrieve the entire configuration information file from one seed IED, or it may retrieve different segments of the file from different seed IEDs using common file sharing techniques (if it found more than one seed IED to provide the requested configuration information file). Either technique may be applied depending on the definition of the peer-to-peer protocol.

After an individual IED has retrieved the new configuration information file, it may act as a peer-to-peer supplier (seed) itself by making the new configuration information file available to other IEDs. This is dependent on the specific peer-to-peer protocol employed, but it does not necessarily require any announcement message to other IEDs. The implementation may be as simple as now replying in the affirmative (where previously it would have replied in the negative) when queried by other peer IEDs to see if the configuration information file is available.

An IED may become a configuration information file supplier even if the device type associated with the configuration information file does not match the LED's device type. In that case, the IED will not subsequently use the configuration information file itself, but it can still participate in the file sharing activity. One example of a common/useful scenario when this might occur is where an IED such as the IED104e of one type is used as a gateway to a serial RS-485 loop such as the serial network 106e of IEDs of a different type. In this example, the CMS 102 may transfer a configuration information file to the gateway device such as the IED 104e, and then the IEDs on the serial loop such as the serial network 106e would use the gateway device, IED 104e, as a seed to retrieve the configuration information file.

In the specific variation where a list file is used to identify the IEDs to upgrade/configure, each IED regularly monitors its seeds for a new list file, and when it finds one it retrieves the list file to determine if it is on the list. The same peer-to-peer technologies described above are employed here, to facilitate the periodic checking and subsequent retrieval of the new list file.

Once the list file has been retrieved, the IED will analyze it to look for a reference to itself. If the list file contains a reference to the IED that identifies it for upgrade or configuration (including information about the file it is supposed to find and when to start using it), then the IED proceeds to retrieve the file from its seed(s). If the list file does not contain any reference to the IED, no action is taken. Once an IED retrieves the list file, it may act as a peer-to-peer supplier (seed) itself by making the new list file available to other IEDs, regardless of whether or not the given IED finds itself on the list.

Once the configuration information file has been downloaded, the IED will need to check to see if the configuration information file that it just uploaded matches its device type. If the device type of the configuration information file does not match the device, the IED will not load the configuration information file. If the device type matches, the IED will then need to know how to use the configuration information that is stored in the configuration information file as well as how to feedback its status to the CMS 102. In this instance, the IED will either have prior knowledge of this information based on a request it received from the CMS 102 or be required to parse the “list file” that is associated with the downloaded configuration information file and figure out if there is information in the file that is of relevance to it.

Based on the request that was sent to the IED or the parsed information, the IED can be instructed to start using the new configuration information file immediately. Alternatively, the IED can be instructed to start using the new configuration information file at a specific date/time. Alternatively, the IED can be instructed to wait for a signal from the CMS 102 to tell it to start using the new configuration information files.

Once the IED has finished using the configuration information file based on the above triggers, the IED will feedback its status to the CMS 102. The feedback can occur by either communicating directly with the CMS 102 and report the LED's status (Success/Failure) of the operation. Alternatively, the feedback can wait for the CMS 102 to query the IED to retrieve the status information.

Any of these algorithms include machine readable instructions for execution by: (a) a processor, (b) a controller, and/or (c) any other suitable processing device. It will be readily understood that the server 112 of the CMS 102 includes such a suitable processing device. Any algorithm disclosed herein, may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine readable instructions represented in any flowchart depicted herein may be implemented manually. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

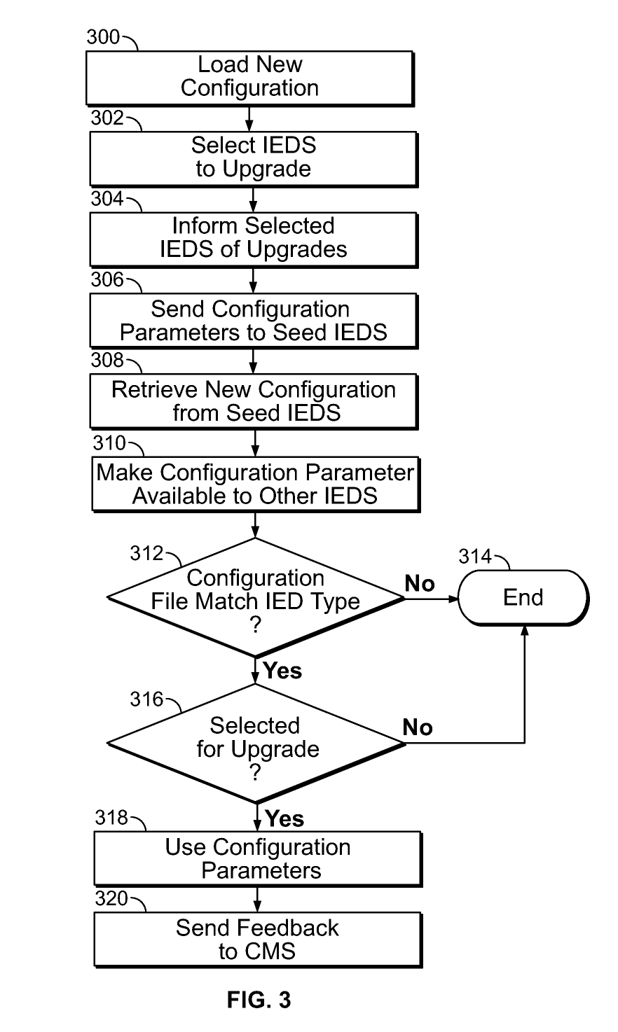

FIG. 3 shows a flow diagram of the process of disseminating configuration information among the IEDs 104a-r in FIGS. 1-2B using peer-to-peer relationships. The new configuration information is loaded in the central storage 110 (300). The user designates the IEDs of the IEDs 104 and 204 in the electrical monitoring system 100 that should receive the new configuration information (302). The designation can be made via user interface to the configuration management algorithm 122 on the server 112. The selected seed IEDs are informed to instruct the peer IEDs to perform the upgrade (304). As explained above, the instruction can either have the CMS 102 communicate with all of the IEDs directly via the network 106 or the CMS 102 writing a list file with the selected seed IEDs and through the seed IEDs sending the list to the remaining IEDs. The CMS 102 sends the configuration information through the networks 106a-f in FIG. 1 to the seed IEDs (306).

The selected IEDs retrieve the upgraded configuration information from the respective seed IEDs (308). The IED can either check the seed IED to determine if the list file has been updated and therefore retrieve a copy of the configuration information, or the IEDs can be programmed to periodically check the seed IED for a new upgrade. The IED then can make the configuration information available to other IEDs (310). Once all of the selected IEDs have received the configuration information, the IEDs each determine whether to update itself using any number of parameters. In this example, the parameter is whether the configuration information matches the device type (312). If the configuration information does not match the device type, the process then ends (314). If the configuration information matches the device type, the IED then determines whether it was selected to receive the upgrade (316). If the IED was not selected to receive the upgrade, the process then ends (314). If the IED matches the device type and was selected, the IED executes the file according to predetermined instructions such as immediately starting to use the file, starting at a certain date and time or waiting for a signal from the CMS 102 (318). Once the new configuration information is used, the IED sends feedback data back to the CMS 102 to report on the success or failure of the operation (320). This can either be initiated by the IED or in response to periodic polling by the CMS 102.

The peer-to-peer method described above allows less network congestion by offloading the processing demands from the CMS 102 by taking advantage of the distributed processing that already exists within the networks 106a-f in FIG. 1. The use of seed IEDs allows many more IEDs to be ultimately configured or reconfigured at the same time as the peer to peer information transfer cascades out. Using this approach, the digital communications traffic over the electrical monitoring system 100 in FIG. 1 can be optimized such that system bridges/bottlenecks have a minimal impact on the time required to program/update the IEDs 104 and 204. By configuring one IED on the other side of a slower network bridge, bottlenecks may be avoided since the configuration is cascaded from the network bridge to the other IEDs on the same side of the bridge. The overall effect of eliminating the need to communicate from the CMS 102 to every IED 104 and 204 is to reduce the overall systems down time associated with the configuring and updating parameters to the IEDs 104 and 204. The time savings therefore increases the window of opportunity to perform the configuring and updating, as well as increasing the flexibility with when and how new updates take effect on the IEDs 104 and 204.

While particular aspects, embodiments, and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A configurable monitoring system comprising:
at least one network;
a plurality of configurable intelligent electronic devices (IEDs) coupled to the at least one network, at least a first configurable IED being a seed IED having a peer-to-peer relationship with a second IED;
a configuration management system (CMS) coupled to the at least one network, the CMS including a storage device storing a master list of configurations of the IEDs and their associated configuration information for each of the plurality of configurable IEDs on the at least one network, wherein the CMS sends at least some part of new configuration information to the first seed IED and the at least some part of the new configuration information is transferred between the first seed IED and the at least one other second IED.

2. The system of claim 1, wherein the new configuration information includes configuration parameters each indicative of a configuration associated with corresponding ones of the IEDs or a software program for a corresponding one of the IEDs.

3. The system of claim 1, wherein the second IED determines from a list file in the seed IED whether the at least some part of new configuration information will be transferred.

4. The system of claim 3, wherein the CMS disseminates the list file for each of the IEDs coupled to the at least one network.

5. The system of claim 1, wherein the CMS disseminates an alert of the new configuration information to the plurality of IEDs over the at least one network.

6. The system of claim 5, wherein the second IED queries the first seed IED regarding whether the at least some part of the new configuration information is available.

7. The system of claim 1, wherein the second IED is in a peer relationship with a third IED and the second IED serves as a seed IED for the third IED, the third IED receiving the at least some part of the configuration information from the second IED.

8. The system of claim 1, wherein the plurality of IEDs receive conditions on when to start using the received new configuration information.

9. The system of claim 1, further comprising a second network including at least one additional IED, and wherein the second IED serves as a gateway for the CMS to the second network with the at least one additional IED.

10. The system of claim 1, wherein the at least one network includes an Ethernet network, a wireless network, or a serial network.

11. The system of claim 1, wherein the first IED stores the at least part of the new configuration information and determines whether the new configuration information matches a type of the first IED; and the first IED not configuring itself with the new configuration information if the first IED is not of the type that matches that of the new configuration information.

12. The system of claim 11, wherein CMS selects a group of IEDs to be configured with the new configuration, and the first IED configures itself with the new configuration information if the first IED is in the selected group.

13. The system of claim 1, wherein the IEDs are one of a group including a meter, a circuit monitor, a circuit breaker, or a relay, and wherein the IED measures an electrical characteristic in the monitoring system and stores on the IED data indicative of the measured electrical characteristic.

14. The system of claim 1, wherein the plurality of IEDs are coupled to at least one of two networks coupled to the CMS.

15. The system of claim 1, wherein the first IED is designated a seed IED by the CMS.

16. The system of claim 1, wherein the IEDs each maintain a list of possible seed IEDs from the multiple IEDs for that IED.

17. The system of claim 1, wherein the second peer IED obtains a second part of the configuration information from another seed IED.

18. A method of configuring IEDs in a network via a configuration management system (CMS), the method comprising:
establishing a peer-to-peer relationship between at least a first and a second IED of a plurality of IEDs, including designating at least one first seed IED and one second peer IED respectively in the relationship;
alerting at least two of the IEDs of a change in configuration;
distributing at least some part of new configuration information from the CMS to the seed IED; and
establishing a peer-to-peer communication to the seed IED to transfer the at least some part of new configuration information to the peer IED.

19. The method of claim 18, wherein the new configuration information includes configuration parameters each indicative of a configuration associated with corresponding ones of the IEDs or a software program for a corresponding one of the IEDs.

20. The method of claim 18, wherein the peer IED determines from a list file in the seed IED whether the at least some part of new configuration information will be transferred.

21. The method of claim 22, further comprising disseminating the list file via the CMS for each of the IEDs coupled to the network.

22. The method of claim 18, further comprising disseminating an alert of the new configuration information via the CMS to the plurality of IEDs over the network.

23. The method of claim 22, wherein the peer IED queries the seed IED regarding whether the at least some part of the new configuration information is available.

24. The method of claim 18, wherein the second peer IED is in a peer relationship with a third IED and the second peer IED serves as a seed IED for the third IED, the third IED receiving the at least some part of the configuration information from the second IED.

25. The method of claim 18, wherein the plurality of IEDs receive conditions on when to start using the received new configuration information.

26. The method of claim 18, wherein the CMS is coupled to a second network including at least one additional IED, and wherein the second IED serves as a gateway for the CMS to the second network with the at least one additional IED.

27. The method of claim 18, wherein the network includes an Ethernet network, a wireless network, or a serial network.

28. The method of claim 18, further comprising:
storing the at least part of the new configuration information in the first IED;
determining whether the new configuration information matches a type of the first IED; and
not configuring the first IED with the new configuration information if the first IED is not of the type that matches that of the new configuration information.

29. The method of claim 28, further comprising:
selecting a group of IEDs to be configured with the new configuration; and
configuring the first IED with the new configuration information if the configuration matches the type of the first IED, and the first IED

30. The method of claim 18, wherein the IEDs are one of a group including a meter, a circuit monitor, a circuit breaker, or a relay, and wherein the IED measures an electrical characteristic in the monitoring system and stores on the IED data indicative of the measured electrical characteristic.

31. The method of claim 18, wherein the first IED is designated a seed IED by the CMS.

32. The method of claim 18, wherein the IEDs each maintain a list of possible seed IEDs from the multiple IEDs for that IED.

33. The method of claim 18, wherein the second peer IED obtains a second part of the configuration information from another seed IED.
